(19) United States
(12) Patent Application Publication
(10) Pub. No.: US 2025/0190632 A1
(43) Pub. Date: Jun. 12, 2025

(54) SOFTWARE/HARDWARE CO-DESIGN FOR MEMORY SAFETY

(71) Applicant: NVIDIA Corporation, Santa Clara, CA (US)

(72) Inventors: Mohamed Tarek Bnziad Mohamed Hassan, Lowell, MA (US); Aamer Jaleel, Northborough, MA (US); Sana Damani, Santa Clara, CA (US); Mark Stephenson, Austin, TX (US); Stephen William Keckler, Austin, TX (US)

(21) Appl. No.: 18/745,846

(22) Filed: Jun. 17, 2024

Related U.S. Application Data
(60) Provisional application No. 63/608,685, filed on Dec. 11, 2023.
(60) Provisional application No. 63/608,691, filed on Dec. 11, 2023.

(51) Int. Cl. G06F 21/78

(52) U.S. Cl. CPC G06F 21/78

(57) ABSTRACT

Applications written in memory unsafe languages, such as C, C++, and CUDA, are vulnerable to a variety of memory safety errors because they do not validate the bounds and lifetime of memory accesses. For example, spatial memory safety errors occur when a pointer is used to access an object beyond its intended bounds while temporal memory safety errors occur when a pointer is used to access an object beyond its lifetime. Memory safety errors can lead to control-flow hijacking, silent data corruption, difficult-to-diagnose crashes, and security exploitation. Unfortunately, existing software-based solutions either provide low error detection coverage or come with significant runtime overheads, and existing hardware-accelerated GPU-based solutions have poor scalability or intrusive hardware changes. The present disclosure provides memory safety using a combination of hardware and software.

### CLAIM OF PRIORITY

This application claims the benefit of U.S. Provisional Application No. 63/608,685 (Attorney Docket No. NVIDP1389+/23-WE-1089US01), titled “PER-OBJECT METADATA LOCATOR FOR EFFICIENT MEMORY SAFETY,” filed Dec. 11, 2023 and U.S. Provisional Application No. 63/608,691 (Attorney Docket No. NVIDP1390+/23-WE-1090US01), titled “SOFTWARE/HARDWARE CO-DESIGN FOR PRACTICAL MEMORY SAFETY,” filed Dec. 11, 2023, the entire contents of which are incorporated herein by reference.

### TECHNICAL FIELD

The present disclosure relates to memory safety processes.

### BACKGROUND

Applications written in memory unsafe languages, such as C, C++, and CUDA, are vulnerable to a variety of memory safety errors because they do not validate the bounds and lifetime of memory accesses. Memory safety errors can lead to control-flow hijacking, silent data corruption, difficult-to-diagnose crashes, and security exploitation.

Spatial memory safety errors occur when a pointer is used to access an object beyond its intended bounds (i.e. base address and size), such as buffer over-flows or under-flows. If the target of the overflow is adjacent to the victim buffer, it is referred to as a linear overflow (e.g. using a large “size” argument in a memcpy call-site). On the other hand, if the target of the overflow is non-adjacent to the victim buffer, it is referred to as a non-linear overflow (e.g. using an arbitrary large array index, a [index]).

Temporal memory safety errors occur when a pointer is used to access an object beyond its lifetime. Examples include use-after-free (UAF), in which the application uses a dangling pointer to access a heap object after it is deleted, and use-after-realloc (UAR), in which the dangling pointer is used after the deleted memory is allocated to a new object.

The lack of memory safety in C and C++ is a serious and long-standing problem on central processing units (CPUs). Graphics processing unit (GPU) programming languages, such as CUDA and OpenACC, are vulnerable to the same threats as they also do not guarantee the validity (bounds and lifetime) of memory accesses. As GPUs are becoming widely used in production, multiple memory safety schemes have been proposed to help developers detect memory safety errors in GPU applications.

While software-based solutions can be immediately used on commodity GPUs, they either provide low error detection coverage or come with significant runtime overheads that limit their usage to early testing stages. On the other hand, existing hardware-accelerated GPU-based solutions offer higher error detection coverage and lower runtime slowdowns at the cost of poor scalability or intrusive hardware changes.

There is thus a need for addressing these and/or other issues associated with the prior art. For example, there is a need to provide memory safety using a combination of hardware and software.

### SUMMARY

A method, non-transitory computer-readable media, and system are disclosed to provide memory safety using a combination of hardware and software. In an embodiment, responsive to a memory access request having a pointer to an object in memory, a first instruction is executed in hardware to retrieve metadata associated with the object, where the first instruction is generated by software; and a second instruction is executed in the hardware to perform a memory safety check using the metadata, where the second instruction is generated by the software.

In another embodiment, responsive to a memory access request having a pointer to an object in memory, the pointer is analyzed to determine an input address for a first instruction to be generated, including: backward slicing from the memory access request through pointer arithmetic until a pointer creation instruction is reached, and determining a candidate base pointer created by the pointer creation instruction, wherein the candidate base pointer is the input address for the first instruction to be generated; the first instruction that causes hardware of the device to retrieve metadata associated with the object is generated; and second instruction that causes the hardware of the device to perform a memory safety check using the metadata is generated.

### BRIEF DESCRIPTION OF THE DRAWINGS

FIG. 1A illustrates a flowchart of a hardware method for providing memory safety based on instructions generated in software, in accordance with an embodiment.

FIG. 1B illustrates a flowchart of a software method for generating instructions to cause hardware to provide memory safety, in accordance with an embodiment.

FIG. 2 illustrates a system comprised of a combination of hardware and software for providing memory safety, in accordance with an embodiment.

FIG. 3 illustrates a metadata loading unit of the hardware of FIG. 2, in accordance with an embodiment.

FIG. 4 illustrates an exemplary input and output of the compiler of FIG. 2, in accordance with an embodiment.

FIG. 5 illustrates a network architecture, in accordance with an embodiment.

FIG. 6 illustrates an exemplary system, in accordance with an embodiment.

### DETAILED DESCRIPTION

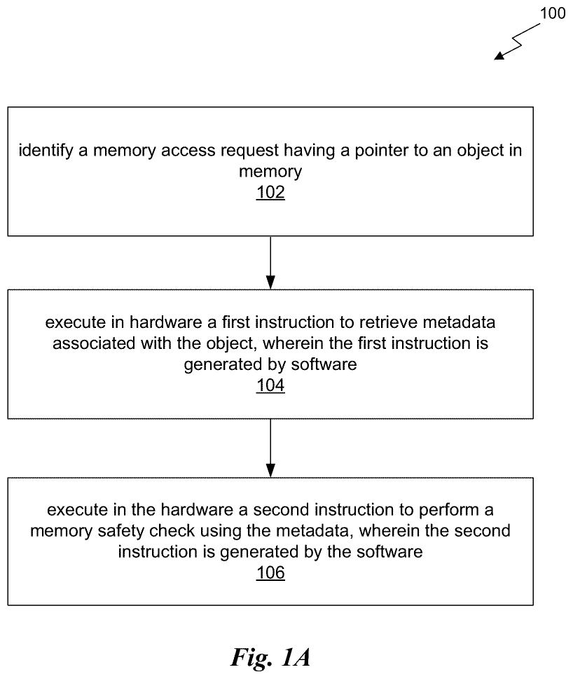

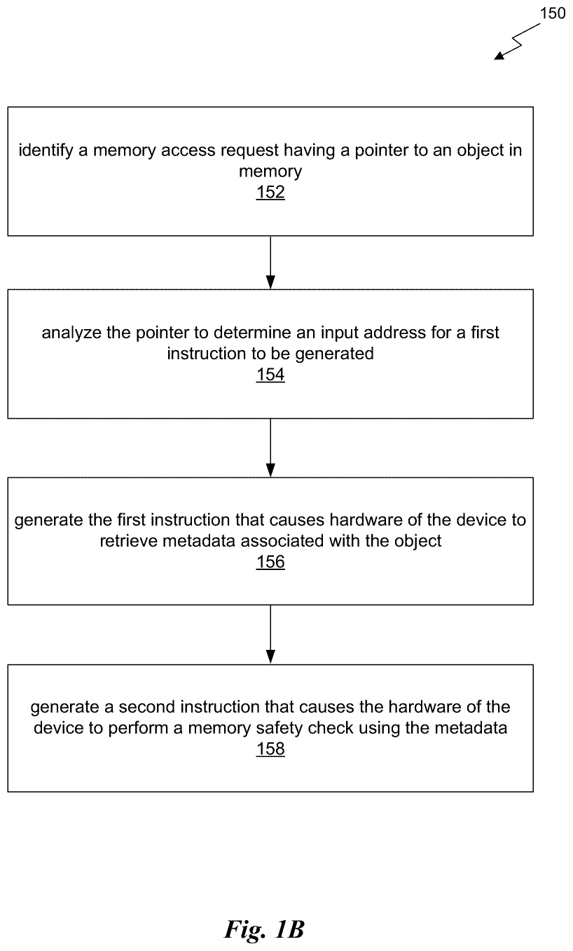

FIG. 1A illustrates a flowchart of a hardware method 100 for providing memory safety based on instructions generated in software, in accordance with an embodiment. The method 100 may be performed by any computer hardware configured to perform the method 100. In an embodiment, the hardware may be a graphics processing unit (GPU). In an embodiment, the hardware may be a specialized hardware.

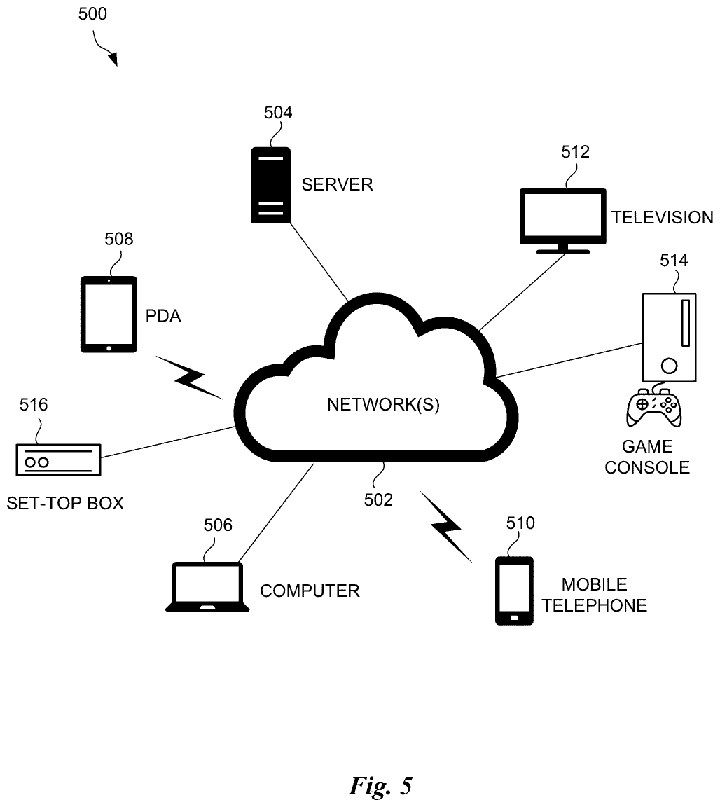

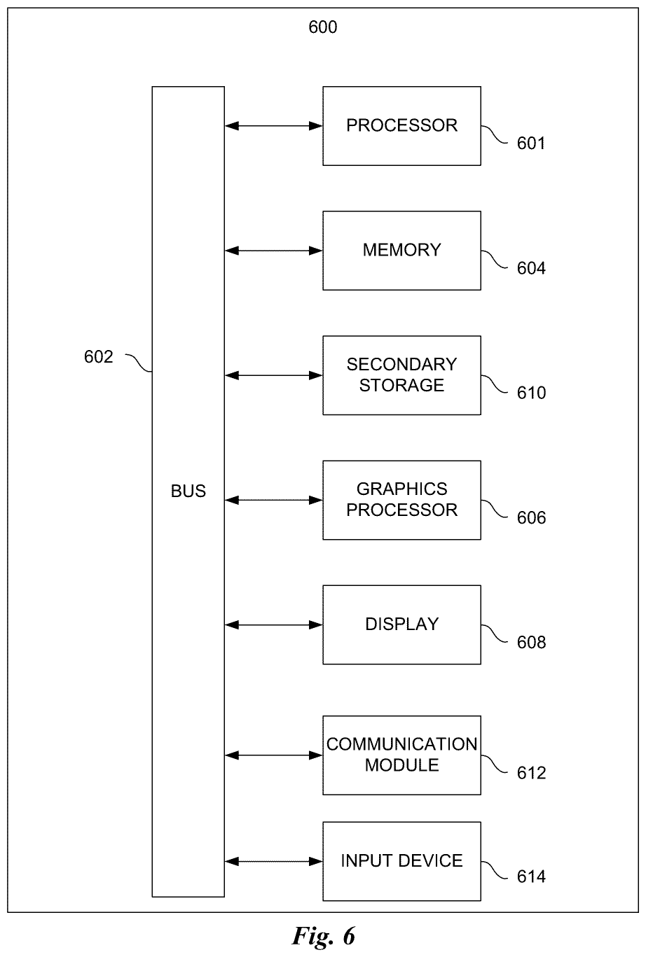

In an embodiment, the hardware may be included in a device, which may be comprised of a processing unit, a program, custom circuitry, or a combination thereof, in an embodiment. In another embodiment, the hardware may be included in a system, which may be comprised of a non-transitory memory storage comprising software (instructions) and one or more processors in communication with the memory which execute the software. As an example, the method 100 may be performed in the context of the devices in the network architecture 500 of FIG. 5 and/or in the context of the system 600 of FIG. 6.

In operation 102, a memory access request having a pointer to an object in memory is identified. The memory access request refers to a function of a computer program. The memory access request is configured to cause memory to be accessed. In particular, the memory access request includes a pointer to a memory region. The memory region represents the object when the memory region has been allocated by a programmer, and in this case the memory access request having the pointer to the object will work correctly to access the object.

In an embodiment, the pointer may point to an arbitrary location in the object. In other words, the pointer does not necessarily have to point to a base address of the object. The computer program may be any program written in a programming language, such as C, C++, CUDA, etc.

It should be noted that in another possible embodiment the memory region may not have been allocated, such that the pointer does not actually point to an intended object. In this case, the memory access request having the pointer to the object will not work correctly. This situation will be detected by the hardware via a verification process, as described in detail below.

In an embodiment, the memory access request may be identified when compiling the computer program. In an embodiment, the method 100 may operate to provide memory safety for the memory access request. For example, a memory safety of the memory access request may be verified prior to accessing (e.g. retrieving, reading, writing to, etc.) the object in the memory.

In operation 104, a first instruction is executed in hardware to retrieve metadata associated with the object, where the first instruction is generated by software. In an embodiment, the software may be a compiler. For example, when the compiler identifies the memory access request in the program, then the compiler may generate the first instruction.

The first instruction is configured to be executed in hardware. As mentioned above, the hardware may be a GPU or other processor, or may be a special purpose hardware, for example. In an embodiment, the first instruction may be generated in a kernel of the hardware.

The first instruction is configured to cause the hardware to retrieve metadata associated with the object. In an embodiment, the metadata may be object-level metadata. For example, the metadata may be created for the object when the object is created in the program. In another embodiment, the metadata may be an N-byte granular metadata.

The metadata refers to any type of data that is required for determining memory safety of the memory access request. Thus, the metadata may include data that is required for the particular memory safety check performed in operation 106 as described below. In an embodiment, the metadata may include a size of the object. In an embodiment, the metadata may include a tag (e.g. generated for the object when the object is created).

The metadata may be retrieved using any preconfigured method/process that the hardware is configured to execute per the first instruction. In an embodiment, the hardware may use a finite state machine (FSM) to retrieve the metadata. In an embodiment, the first instruction may cause the hardware to first search a metadata lookaside buffer (MLB) for the metadata, wherein the MLB stores metadata for recently access objects.

In an embodiment, the first instruction may include as input a base address associated with the pointer. In an embodiment, the first instruction may cause the hardware to use the base address associated with the pointer to retrieve the metadata. As noted above, the metadata may include a size of the object and/or a tag.

In an embodiment, the first instruction may also cause the hardware to perform at least one verification of the metadata. In an embodiment, the verification may include verifying that a difference between the base address associated with the pointer (e.g. as specified in the first instruction) and a location of the metadata (i.e. in the memory) is smaller than a size indicated in the metadata. In this embodiment, the verification may fail when the difference between the base address associated with the pointer and the location of the metadata is greater than the size indicated in the metadata. Likewise, the verification may succeed when the difference between the base address associated with the pointer and the location of the metadata is smaller than (or equal to) the size indicated in the metadata.

In another embodiment, the verification may include verifying that a tag of the base address associated with the pointer matches a tag indicated in the metadata. In this embodiment, the verification may fail when the tag of the base address associated with the pointer does not match the tag indicated in the metadata. The verification may succeed when the tag of the base address associated with the pointer matches the tag indicated in the metadata.

In an embodiment, the first instruction may return a zero when the at least one verification fails. In an embodiment, the first instruction may return a zero when the metadata does not exist. When the first instruction returns a zero, the hardware may detect an error and the method 100 may terminate. On the other hand, the first instruction may return the metadata when the metadata exists and/or when the at least one verification succeeds.

In operation 106, a second instruction is executed in the hardware to perform a memory safety check using the metadata, where the second instruction is generated by the software. Again, the software may be a compiler. The second instruction may be generated when the first instruction is generated, in an embodiment.

The second instruction is configured to be executed in the hardware. In an embodiment, the second instruction may be generated in a kernel of the hardware. The second instruction is configured to cause the hardware to perform a memory safety check using the metadata retrieved via the first instruction.

In an embodiment, the metadata retrieved by the first instruction may be propagated to the second instruction. For example, the metadata may be inserted as the input to the second instruction. In an embodiment, the compiler may propagate the metadata to the second instruction. Thus, in this embodiment the hardware may perform the memory safety check using the metadata specified as the input to the second instruction.

In another embodiment, the second instruction may include as input a memory address corresponding to the pointer and a location of the metadata. The compiler may generate this memory address and metadata location as the input to the second instruction. In this embodiment, the second instruction may cause the hardware to use the location of the metadata (indicated in the input) to retrieve the metadata, or to retrieve one or more pieces of data included in the metadata such as the size of the object and/or the tag.

The memory safety check refers to predefined method/process by which memory safety of the memory access request is verified using the metadata. The memory safety check may verify spatial memory safety, in an embodiment. A spatial memory safety error may occur when a pointer is used to access an object beyond its intended bounds (i.e. base address and size), such as buffer over-flows or buffer under-flows. If the target of the overflow is adjacent to the victim buffer, it is referred to as linear overflow (e.g. using a large “size” argument in a memcpy call-site). On the other hand, if the target of the overflow is non-adjacent to the victim buffer, it is referred to as non-linear overflow (e.g. using an arbitrary large array index, a [index]). With regard to checking spatial memory safety, the second instruction may cause the hardware to perform the memory safety check by computing a difference between the address corresponding to the pointer and the location of the metadata, and raising an exception when the difference is greater than the size.

The memory safety check may verify temporal memory safety, in an embodiment. A temporal memory safety error occurs when a pointer is used to access an object beyond its lifetime. Examples include use-after-free (UAF) in which the program uses a dangling pointer to access a heap object after it is deleted, and use-after-realloc (UAR) in which the dangling pointer is used after the deleted memory is allocated to a new object. With regard to checking temporal memory safety, the second instruction may cause the hardware to perform the memory safety check by comparing a portion of the address corresponding to the pointer with the tag, and raising an exception when the portion of the address does not match the tag.

To this end, when the memory safety check indicates an unsafe memory condition, an indication of the unsafe memory condition (e.g. an error) may be returned. Further, when the memory safety check indicates a safe memory condition, the memory access may be performed.

To this end, the method 100 may be executed in hardware (e.g. a GPU) to both retrieve metadata for an object pointed to by a memory access request and to use that metadata to perform a memory safety check for the memory access request. The hardware method 100 specifically relies on instructions, including the first and second instructions defined above, which are created by software (e.g. a compiler). The software method 150 described below discloses an embodiment of the manner by which the instructions are created for execution by the hardware.

While the method 100 refers to first and second instructions, it should be noted that in another embodiment a single instruction may retrieve the metadata and perform the memory safety check using the metadata, in accordance with the descriptions above. In this embodiment, the base pointer and the memory address being accessed may be passed to the single instruction. In yet another embodiment, a single instruction may perform the memory safety check using the metadata and perform the memory access based on the result of the memory safety check. Accordingly, various embodiments are contemplated in which at least one instruction is executed in hardware to retrieve metadata associated with the object, perform a memory safety check using the metadata, and perform the memory access based on a result of the memory safety check, where such at least one instruction is generated by software.

FIG. 1B illustrates a flowchart of a software method 150 for generating instructions to cause hardware to provide memory safety, in accordance with an embodiment. The method 100 may be performed by any computer software configured to perform the method 150. In an embodiment, the software may be a compiler.

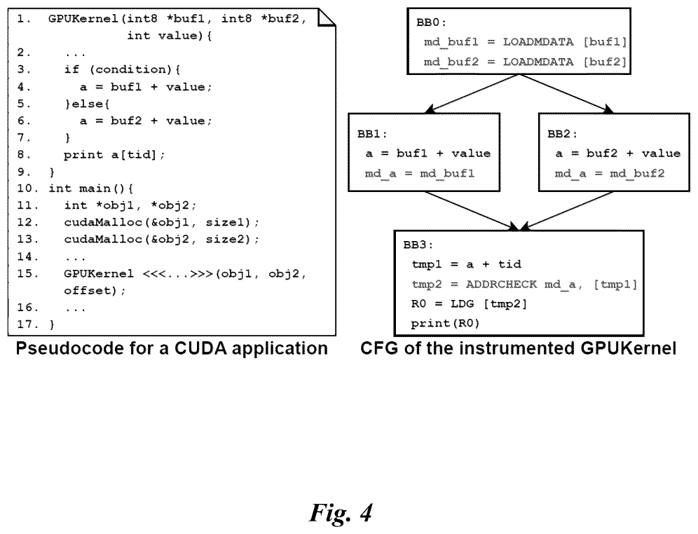

In an embodiment, the software may be executed by a device, which may be comprised of a processing unit, a program, custom circuitry, or a combination thereof. In another embodiment, the software may be executed by a system, which may be comprised of a non-transitory memory storage comprising the software and one or more processors in communication with the memory which execute the software. In another embodiment, a non-transitory computer-readable media may store the software which when executed by one or more processors of a device cause the device to perform the method 150. As an example, the method 150 may be performed in the context of the devices in the network architecture 400 of FIG. 4 and/or in the context of the system 500 of FIG. 5.

As mentioned above, software method 150 discloses an embodiment of the manner in which the instructions executed via the hardware method 100 are created. Thus, the descriptions and/or definitions given above my equally apply to the present description.

In operation 152, a memory access request having a pointer to an object in memory is identified. In an embodiment, the memory access request may be identified when compiling a computer program having the memory access request. In another embodiment the memory access request may be identified prior to compiling the computer program.

In operation 154, the pointer is analyzed to determine an input address for a first instruction to be generated. The analysis may be a static-time or a compile-time analysis of the pointer. With respect to the present embodiment, the pointer is analyzed by backward slicing from the memory access request through pointer arithmetic until a pointer creation instruction is reached, and then determining a candidate (e.g. potential, compiler-identified) base pointer created by the pointer creation instruction. The candidate base pointer is the input address for the first instruction. It should be noted that this analysis is not guaranteed to find the true base pointer of the object in all cases. For example, the pointer creation instruction might be a load instruction that loads a non-base pointer from memory. In this case, analysis will identify this non-base address as a candidate base pointer and provide it as an input address to the first instruction.

In operation 156, the first instruction that causes hardware of the device to retrieve metadata associated with the object is generated. As mentioned, the first instruction includes the candidate base pointer as the input address. Accordingly, the first instruction is generated to cause the hardware to use the candidate base pointer to retrieve the metadata associated with the object. Where the candidate base pointer is not the true base pointer of the object, then the hardware will use the candidate base pointer to retrieve the true base pointer of the object.

In operation 158, a second instruction that causes the hardware of the device to perform a memory safety check using the metadata is generated. In an embodiment, the metadata retrieved by the first instruction may be propagated to the second instruction. For example, the metadata may be specified as the input to the second instruction. Thus, the second instruction may cause the hardware to directly perform the memory safety check using the metadata.

In another embodiment, the second instruction may include as input a memory address corresponding to the pointer and a location of the metadata. In this embodiment, the second instruction may cause the hardware to use the location of the metadata to retrieve the metadata or any portion thereof (e.g. a size indicated in the metadata).

In an embodiment, the software may insert the first instruction and the second instruction in a control flow graph generated for the program having the memory access request. In an embodiment, the first instruction may be inserted at a location in the control flow graph corresponding to the memory access request. The hardware may then use the control flow graph, and in particular the first and second instructions inserted therein, to perform the memory safety check when executing the program. For example, the hardware may execute the first and second instructions per the method 100 of FIG. 1A.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

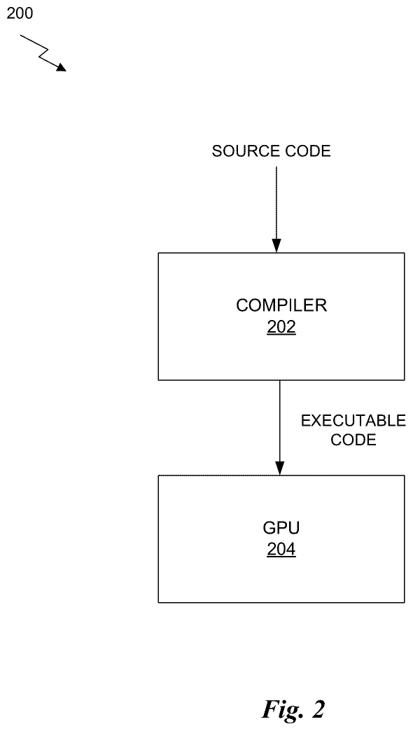

FIG. 2 illustrates a system 200 comprised of a combination of hardware and software for providing memory safety, in accordance with an embodiment. The system 200 may be configured to carry out the method 100 FIG. 1A and/or the method 150 of FIG. 1B.

As shown, the system 200 includes a compiler 202 as the software and a GPU 204 as the hardware. However, it should be noted that other implementations of the software and/or hardware may be used in the system 200.

The compiler 202 compiles a program written in source code to form executable code capable of being executed by the GPU 204. Responsive to a memory access request having a pointer to an object in memory, the compiler 202 generates a first instruction to cause the GPU 204 to retrieve metadata associated with the object. The first instruction includes an input address to be used by the GPU 204 to retrieve the metadata.

In an embodiment, the compiler 202 analyzes the pointer to determine an input address for the first instruction. The analysis may be a static-time or a compile-time analysis of the pointer. With respect to the present embodiment, the pointer is analyzed by backward slicing from the memory access request through pointer arithmetic until a pointer creation instruction is reached, and then determining a compiler-identified base pointer created by the pointer creation instruction. The compiler 202 generates the first instruction with the compiler-identified base pointer as the input address.

The compiler 202 generates a second instruction to cause the GPU 204 to perform a memory safety check using the metadata. In an embodiment, the compiler 202 propagates the metadata to the second instruction. In particular, the metadata is specified as input to the second instruction. In another embodiment, the second instruction includes as input a memory address corresponding to the pointer and a location of the metadata to cause the hardware to use the location of the metadata to retrieve the metadata or any portion thereof (e.g. a size indicated in the metadata).

In an embodiment, the compiler 202 may insert the first instruction and the second instruction in a control flow graph generated for the program having the memory access request. In an embodiment, the first instruction may be inserted at a location in the control flow graph corresponding to the memory access request. One example of generating the control flow graph is described below with reference to FIG. 4. The control flow graph represents the instrumented GPU kernel, or in other words the executable code for the GPU 204.

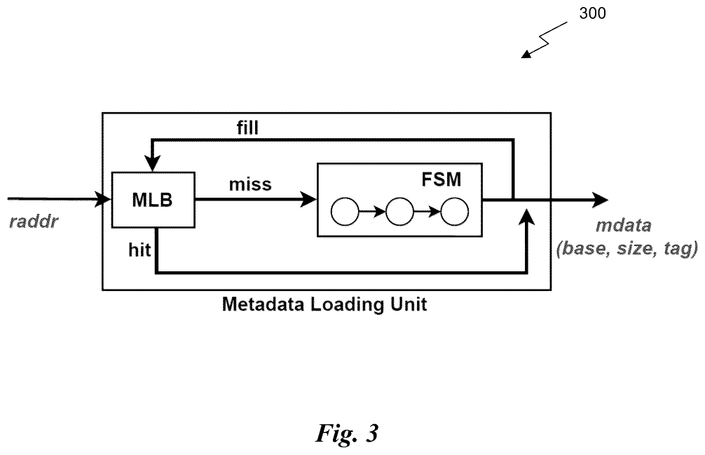

The GPU 204 uses the control flow graph, and in particular the first and second instructions inserted therein, to perform the memory safety check when executing the program. In an embodiment, as the GPU 204 executes the program (e.g. via the control flow graph) the GPU encounters the first instruction. The GPU 204 executes the first instruction to retrieve the metadata for the object. In an embodiment, a metadata loading unit of the GPU 204, as described in FIG. 3, may be used to retrieve the metadata.

The GPU 204 continues to the second instruction and then executes the second instruction to perform the memory safety check for the memory access request. The GPU 204 proceeds with returning the object based upon a result of the memory safety check. In an embodiment, when the memory safety check fails, then an error or error code (e.g. a zero) is returned instead of the object. In an embodiment, when the memory safety check succeeds, then the object is returned.

FIG. 3 illustrates a metadata loading unit of the hardware of FIG. 2, in accordance with an embodiment.

When retrieving the memory safety metadata, the GPU 204 can incur serial memory accesses depending on the method/process required to access the metadata. In an embodiment, these memory accesses can be incurred using a metadata loading unit in addition to hardware logic of the GPU 204 that performs the memory safety check.

The metadata loading unit is responsible for retrieving the metadata (e.g. base address, size, and tag) of the object pointed-to by a given memory address (raddr). In an embodiment, the metadata loading unit is co-located with the load-store unit in the GPU 204 memory input-output block. In an embodiment, the memory addresses across all threads of the warp are first coalesced by the memory coalescing unit. The metadata loading unit then fetches the metadata associated with the coalesced memory address. To perform this operation, the metadata loading unit implements the finite state machine (FSM) shown in FIG. 3.

The metadata loading unit uses the input address, raddr, to retrieve the metadata. To accelerate metadata retrieval, the metadata loading unit first consults a metadata lookaside buffer (MLB) which holds the metadata for recently accessed objects. In an embodiment, each MLB entry consists of the 16B metadata (e.g. with base, size, and tag) for recently accessed objects. An MLB lookup finds the MLB entry whose range (i.e. [base, base+size]) covers the lookup address. On a hit, the metadata of the matching entry is returned to the Streaming Multiprocessor (SM). On a miss, the metadata loading unit uses the FSM to retrieve the metadata and send it to the SM. In an embodiment, a small 16-entry MLB may be used to reduce power and meet timing requirements. In an embodiment, MLB entries may be invalidated when objects are deleted.

In an embodiment, the logic for performing the memory safety checks may be implemented as an extension to the SM functional unit. In an embodiment, if the memory safety check fails, a device-side exception is raised, which can then be captured by the host-side application code. The in-line metadata may always be protected as the hardware is aware of the metadata location and thus any memory accesses targeting the metadata will be considered memory safety errors unless the accesses are originating from dynamic memory management wrappers. Such memory management wrappers are described below.

To maintain compatibility with accesses to local memory regions in shared libraries), the value of 0x0 may be left unused while assigning the random tags. The metadata retrieval and safety checks may only be performed for memory addresses with non-zero tags. Afterwards, the GPU 204 hardware may mask off the tag bits before sending the data request to the memory hierarchy.

FIG. 4 illustrates an exemplary input and output of the compiler of FIG. 2, in accordance with an embodiment.

By way of context, architectural support and static-time compiler analysis may be used for increasing the memory safety error detection coverage beyond the probabilistic memory tagging guarantees. As disclosed with respect to FIG. 2, memory safety may be provided using a software-hardware co-design where the compiler 202 inserts two new instructions: LOADMDATA and ADDRCHECK in the appropriate locations and the GPU 204 uses them as trigger points for retrieving metadata and performing safety checks. The compiler analysis positions the LOADMDATA instructions in such a manner so as to prevent pointer arithmetic instructions from corrupting the LOADMDATA inputs. This way, the true base and bounds of each pointer may be maintained, achieving higher error detection coverage on average.

In an embodiment, the metadata may be populated using software upon allocation and deletion. For example, runtime wrappers around memory management functions (e.g. cudaMalloc and cudaFree on GPUs and malloc/free on CPUs) may be used to populate the metadata usable for memory safety (e.g. object size and tag). After the metadata is populated or set, the GPU 204 can retrieve them at runtime as described herein. Using the wrappers around the memory management application programming interfaces (APIs) instead of directly modifying the APIs themselves provides compatibility with the different memory allocators running on the GPU 204 or other hardware (e.g. CPU). The following two instructions are added to the GPU 204 instruction set architecture (ISA) for fetching and using the metadata.

mdata.base=LOADMDATA [raddr]. This instruction takes a 64-bit compiler-identified base address (raddr) as input and returns its associated 64-bit metadata location (mdata.base) as output. In an embodiment, upon executing this instruction, the GPU 204 computes the metadata (obj_mdata) location associated with the object pointed-to by raddr according to a defined algorithm and fetches the obj_mdata (e.g. 64-bit base address mdata.base, and 64-bit size mdata.size, and tag mdata.tag) into the MLB. To avoid accidentally fetching the metadata of an unrelated object, this instruction may be configured to also verify that (1) the difference between raddr and mdata.base is smaller than mdata.size and (2) the raddr's tag matches the mdata.tag. The instruction returns zero otherwise. Similarly, the instruction returns zero if the metadata does not exist (e.g. a corrupted pointer is used as raddr) without raising an exception to avoid false positives.

new_addr=ADDRCHECK mdata.base, addr. This instruction takes a 64-bit memory address (addr) and 64-bit metadata location (mdata.base) as input and returns an untagged 64-bit memory address (new_addr). The whole 128-bit metadata is not used as input to (1) reduce register pressure and (2) avoid storing stale mdata.tag into registers for long running kernels. Upon executing this instruction, the GPU 204 uses mdata.base to get the metadata (mdata.size and mdata.tag) from the MLB. Then it computes the difference between the addr and mdata.base and compares it to mdata.size. It also compares the upper 16 (or 7 on 57-bit systems) bits of addr with mdata.tag. An exception is raised if (1) the memory access is not within legitimate bounds or (2) there is a tag mismatch.

Returning to the example show in FIG. 4, an instrumentation pass is implemented in the GPU-compute compiler 202 backend to leverage the ISA extensions mentioned above. To properly insert the LOADMDATA instructions, an intra-procedural analysis (called the base pointer analysis) is used to identify the minimal set of pointers from which all other pointers are derived within a function. This analysis works by backward slicing from memory instruction (i.e. use-site) through pointer arithmetic until the pointer creation instruction (i.e. def-site) is reached. Identifying the def-sites allows fewer LOADMDATAs to be inserted (i.e. for better performance) while avoiding pointer arithmetic side effects (i.e. for higher error detection coverage).

Once the pointer use and def sites are identified, the new instructions are inserted, as demonstrated in FIG. 4 which shows a simple example of a CUDA program with its control flow graph. In the example shown, the compiler analysis identifies buf1 and buf2 as the reaching base pointers for the global load instruction, LDG in BB3. Thus, LOADMDATA instructions are added in BB0 to read the memory safety metadata and propagate its location (using MOV instructions in BB1 and BB2) until the usage site in BB3 is reached, in which the ADDRCHECK instruction is added for performing the memory safety checks. To this end, LOADMDATAs are inserted closer to the pointer use-site while using the compiler inputs captured at the pointer def-site.

FIG. 5 illustrates a network architecture 500, in accordance with one possible embodiment. As shown, at least one network 502 is provided. In the context of the present network architecture 500, the network 502 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 502 may be provided.

Coupled to the network 502 is a plurality of devices. For example, a server computer 504 and an end user computer 506 may be coupled to the network 502 for communication purposes. Such end user computer 506 may include a desktop computer, lap-top computer, and/or any other type of logic. Still yet, various other devices may be coupled to the network 502 including a personal digital assistant (PDA) device 508, a mobile phone device 510, a television 512, a game console 514, a television set-top box 516, etc.

FIG. 6 illustrates an exemplary system 600, in accordance with one embodiment. As an option, the system 600 may be implemented in the context of any of the devices of the network architecture 500 of FIG. 5. Of course, the system 600 may be implemented in any desired environment.

As shown, a system 600 is provided including at least one central processor 601 which is connected to a communication bus 602. The system 600 also includes main memory 604 [e.g. random access memory (RAM), etc.]. The system 600 also includes a graphics processor 606 and a display 608.

The system 600 may also include a secondary storage 610. The secondary storage 610 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 604, the secondary storage 610, and/or any other memory, for that matter. Such computer programs, when executed, enable the system 600 to perform various functions (as set forth above, for example). Memory 604, storage 610 and/or any other storage are possible examples of non-transitory computer-readable media.

The system 600 may also include one or more communication modules 612. The communication module 612 may be operable to facilitate communication between the system 600 and one or more networks, and/or with one or more devices through a variety of possible standard or proprietary communication protocols (e.g. via Bluetooth, Near Field Communication (NFC), Cellular communication, etc.).

As also shown, the system 600 may include one or more input devices 614. The input devices 614 may be wired or wireless input device. In various embodiments, each input device 614 may include a keyboard, touch pad, touch screen, game controller (e.g. to a game console), remote controller (e.g. to a set-top box or television), or any other device capable of being used by a user to provide input to the system 600.

As described herein, a method, computer readable medium, and system are disclosed to provide memory safety using a combination of hardware and software. In accordance with FIGS. 1-4, embodiments may provide a software and hardware co-design, which may in turn be used for providing memory safety. The hardware and/or software may be implemented in the context of any of the devices depicted in FIGS. 5 and/or 6.

What is claimed is:

1. A method, comprising:
at a device, responsive to a memory access request having a pointer to an object in memory:
executing in hardware a first instruction to retrieve metadata associated with the object, wherein the first instruction is generated by software; and
executing in the hardware a second instruction to perform a memory safety check using the metadata, wherein the second instruction is generated by the software;
when the memory safety check indicates an unsafe memory condition, returning an indication of the unsafe memory condition; and
when the memory safety check indicates a safe memory condition, performing the memory access.

2. The method of claim 1, wherein the pointer points to an arbitrary location in the object.

3. The method of claim 1, wherein the metadata is object-level metadata.

4. The method of claim 1, wherein the metadata is an N-byte granular metadata.

5. The method of claim 1, wherein the metadata includes at least one of:
a size of the object, or
a tag.

6. The method of claim 1, wherein the software is a compiler.

7. The method of claim 6, wherein the compiler inserts the first instruction and the second instruction in a control flow graph generated for a program having the memory access request.

8. The method of claim 7, wherein the first instruction is inserted at a location in the control flow graph and with an input address both determined by a static-time or a compile-time analysis of the pointer.

9. The method of claim 8, wherein the analysis includes backward slicing from the memory access request through pointer arithmetic until a pointer creation instruction is reached.

10. The method of claim 9, wherein the first instruction is inserted in the control flow graph and corresponds to the memory access request, and wherein the first instruction includes as the input address a compiler-identified base pointer created by the pointer creation instruction.

11. The method of claim 10, wherein the compiler propagates the metadata retrieved by the first instruction to the second instruction.

12. The method of claim 1, wherein the first instruction includes as input a base address associated with the pointer.

13. The method of claim 12, wherein the first instruction causes the hardware to use the base address associated with the pointer to retrieve the metadata which includes at least one of:
a size of the object, or
a tag.

14. The method of claim 13, wherein the first instruction causes the hardware to perform at least one verification of the metadata.

15. The method of claim 14, wherein the at least one verification includes verifying that a difference between the base address associated with the pointer and a location of the metadata is smaller than a size indicated in the metadata.

16. The method of claim 14, wherein the at least one verification includes verifying that a tag of the base address associated with the pointer matches a tag indicated in the metadata.

17. The method of claim 14, wherein the first instruction returns a zero when the at least one verification fails.

18. The method of claim 1, wherein the first instruction returns a zero when the metadata does not exist.

19. The method of claim 1, wherein the second instruction includes as input a memory address corresponding to the pointer and a location of the metadata.

20. The method of claim 19, wherein the second instruction causes the hardware to use the location of the metadata to retrieve from the metadata a size.

21. The method of claim 20, wherein the second instruction causes the hardware to perform the memory safety check by:
computing a difference between the address corresponding to the pointer and the location of the metadata, and
raising an exception when the difference is greater than the size.

22. The method of claim 20, wherein a tag is further retrieved from the metadata, and wherein the second instruction causes the hardware to perform the memory safety check by:
comparing a portion of the address corresponding to the pointer with the tag, and
raising an exception when the portion of the address does not match the tag.

23. The method of claim 1, wherein the second instruction includes as input the metadata.

24. The method of claim 1, wherein the hardware uses a finite state machine (FSM) to retrieve the metadata.

25. The method of claim 1, wherein the first instruction causes the hardware to first search a metadata lookaside buffer (MLB) for the metadata, wherein the MLB stores metadata for recently access objects.

26. The method of claim 1, wherein the hardware is a graphics processing unit (GPU).

27. A system, comprising:
computer hardware that is responsive to a memory access request having a pointer to an object in memory to:
execute a first instruction to retrieve metadata associated with the object, wherein the first instruction is generated by software; and
execute a second instruction to perform a memory safety check using the metadata, wherein the second instruction is generated by the software;
when the memory safety check indicates an unsafe memory condition, returning an indication of the unsafe memory condition; and
when the memory safety check indicates a safe memory condition, performing the memory access.

28. The system of claim 27, wherein the computer hardware is a graphics processing unit (GPU).

29. The system of claim 27, wherein the system further comprises:
a non-transitory memory storage comprising the software; and
at least one processor that executes the software to generate the first instruction and the second instruction.

30. The system of claim 29, wherein the software is a compiler.

31. The system of claim 29, wherein the at least one processor is a central processing unit (CPU).

32. A non-transitory computer-readable media storing software which when executed by one or more processors of a device cause the device, responsive to a memory access request having a pointer to an object in memory, to:
analyze the pointer to determine an input address for a first instruction to be generated, including:
backward slicing from the memory access request through pointer arithmetic until a pointer creation instruction is reached, and
determining a candidate base pointer created by the pointer creation instruction, wherein the candidate base pointer is the input address for the first instruction to be generated;
generate the first instruction that causes hardware of the device to retrieve metadata associated with the object; and
generate a second instruction that causes the hardware of the device to perform a memory safety check using the metadata.

33. The non-transitory computer-readable media of claim 32, wherein the metadata is object-level metadata.

34. The non-transitory computer-readable media of claim 32, wherein the metadata is an N-byte granular metadata.

35. The non-transitory computer-readable media of claim 32, wherein the software is a compiler.

36. The non-transitory computer-readable media of claim 35, wherein the compiler inserts the first instruction and the second instruction in a control flow graph generated for a program having the memory access request.

37. The non-transitory computer-readable media of claim 36, wherein the input address for the first instruction is determined by a static-time or a compile-time analysis of the pointer.

38. The non-transitory computer-readable media of claim 37, wherein the first instruction is inserted at a location in the control flow graph corresponding to the memory access request.

39. The non-transitory computer-readable media of claim 38, wherein the compiler propagates the metadata retrieved by the first instruction to the second instruction.

40. The non-transitory computer-readable media of claim 32, wherein the first instruction causes the hardware to use the input address to retrieve the metadata which includes at least one of:
a size of the object, or
a tag.

41. The non-transitory computer-readable media of claim 32, wherein the first instruction causes the hardware to perform at least one verification of the metadata.

42. The non-transitory computer-readable media of claim 32, wherein the second instruction includes as input a memory address corresponding to the pointer and a location of the metadata.

43. The non-transitory computer-readable media of claim 42, wherein the second instruction causes the hardware to use the location of the metadata to retrieve from the metadata a size.

44. The non-transitory computer-readable media of claim 43, wherein the second instruction causes the hardware to perform the memory safety check by:
computing a difference between the address corresponding to the pointer and the location of the metadata, and
raising an exception when the difference is greater than the size.

45. The non-transitory computer-readable media of claim 43, wherein a tag is further retrieved from the metadata, and wherein the second instruction causes the hardware to perform the memory safety check by:
comparing a portion of the address corresponding to the pointer with the tag, and
raising an exception when the portion of the address does not match the tag.

46. The non-transitory computer-readable media of claim 32, wherein the second instruction includes as input the metadata.

47. The non-transitory computer-readable media of claim 32, wherein the hardware is a graphics processing unit (GPU).

48. A method, comprising:
at a device, responsive to a memory access request having a pointer to an object in memory:
executing at least one instruction in hardware to:
retrieve metadata associated with the object,
perform a memory safety check using the metadata, and
perform the memory access based on a result of the memory safety check;
wherein the at least one instruction is generated by software.

49. The method of claim 48, wherein the at least one instruction includes a single instruction that retrieves the metadata and performs the memory safety check using the metadata.

50. The method of claim 48, wherein the at least one instruction includes a single instruction that performs the memory safety check using the metadata and performs the memory access based on the result of the memory safety check.
